(19) United States
(12) Patent Application Publication
(10) Pub. No.: US 2012/0054600 A1
(43) Pub. Date: Mar. 1, 2012

(54) IMAGE CLUSTERING AND PAGE LAYOUT SYSTEM AND METHOD

(75) Inventors: Kevin McCurdy, Hanover, NH (US); Dennis John, Meridian, ID (US)

(73) Assignee: PICABOO CORPORATION, Menlo Park, CA (US)

(21) Appl. No.: 12/872,369

(22) Filed: Aug. 31, 2010

(51) Int. Cl. G06F 17/00

(52) U.S. Cl. 715/243

(57) ABSTRACT

An image/photo clustering and book page layout system and method based on photo/image metadata are described.

### FIELD

The disclosure relates generally to a system and method for generating a photo book and in particular to a system and method for indexing images/photos to generate a photo book.

### BACKGROUND

Systems and method that permit a user to organize a plurality of pieces of content are known. For example, the Picture Manager utility in Windows® allows a user to view a plurality of digital images, arrange the digital images and then view the plurality of digital images as a slide show. In addition, one can use Microsoft® Powerpoint® to generate and arrange a series of slides wherein each slide can contain one or more digital images so that a slideshow with the slides containing the digital images is generated. In addition, video editing system (both high end movie studio type systems and consumer systems) exist that allow a user to put together clips of video images into a movie or other video show.

However, no existing system is capable of clustering images and then generating a page layout for a photo book and it is to this end that the system and method are directed.

### BRIEF DESCRIPTION OF THE DRAWINGS

FIG. 1A is an example of an implementation of the photo story book system that incorporates the image clustering and layout capabilities;

FIG. 1B illustrates more details of the client computing device of the photo story book system;

FIGS. 2A and 2B illustrate a image clustering and book layout method that can be implemented using the photo story book system in FIG. 1;

FIG. 3 illustrates more details of a layout method that is part of the method shown in FIGS. 2A and 2B;

FIG. 4 illustrates an example of a set of image metadata used for indexing the content;

FIG. 5 illustrates an example of a set of clusters generated for the set of image metadata shown in FIG. 4;

FIG. 6 illustrates the set of clusters generated for the set of image metadata shown in FIG. 4 in an XML format; and

FIG. 7 illustrates an example of the book layout based on the clusters and image metadata shown in FIGS. 4-6.

### DETAILED DESCRIPTION OF ONE OR MORE EMBODIMENTS

The disclosure is particularly applicable to a web-based photo/image book generation system and method and it is in this context that the disclosure will be described. It will be appreciated, however, that the system and method has greater utility since it can be implemented using various different hardware and software different than those disclosed below and may be used as a independent system (not part of the web-based photo book system), as part of a different content system, as a desktop application that is connected to the Internet and a web site (such as the photo book system, or with other systems in which it is desirable to be able to preview, assemble and generate a bound book of digital images. In addition, the content clustered and laid out in the book may be various types of content including text and the like. Now, an example of a photo book system and method that can utilize the image/photo clustering and layout system and method is described for illustration purposes.

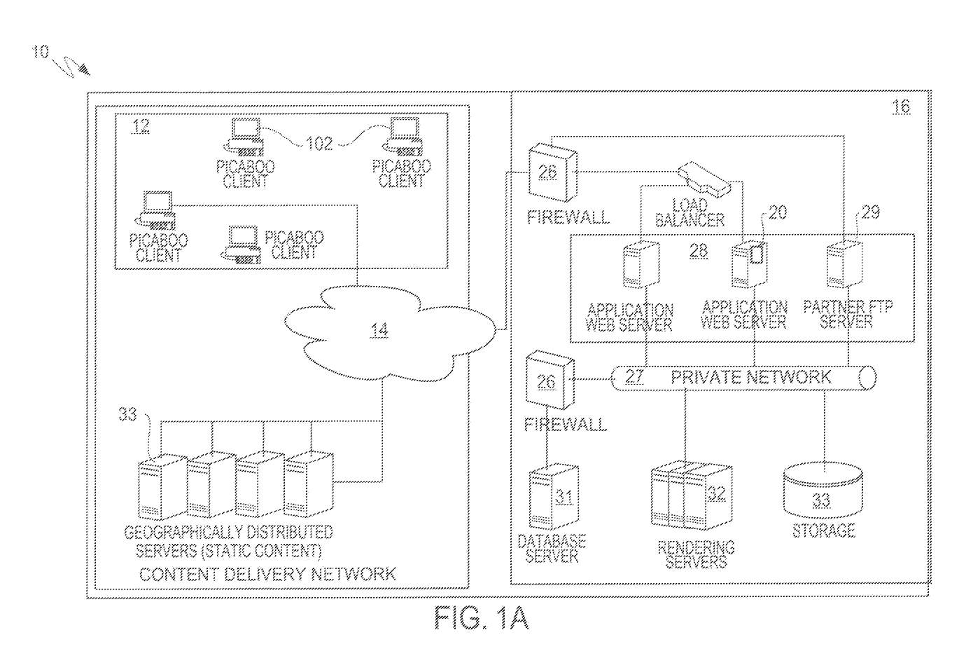

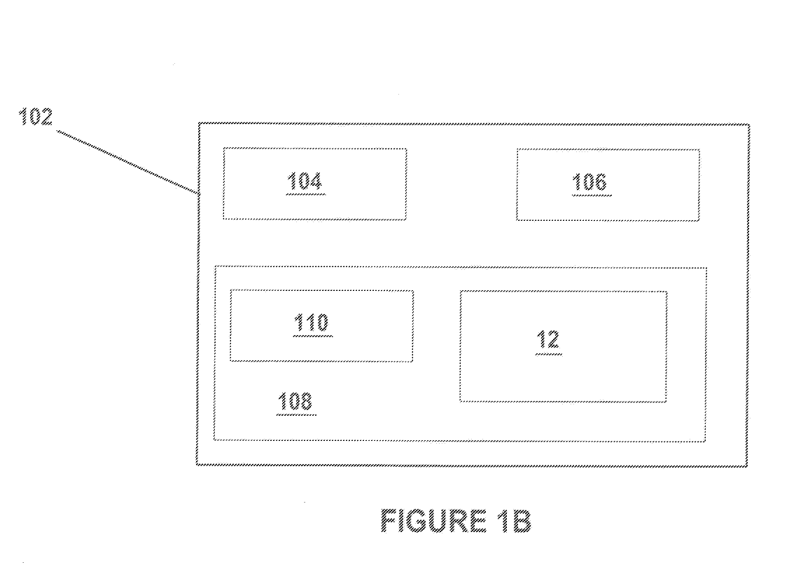

FIG. 1A is an example of an implementation of a web based photo story book system 10 that incorporates the image clustering and layout capabilities. The web-based system, that may be a photo book system of Picaboo (www.picaboo.com) may include one or more computing devices 102 (such as the plurality of Picaboo clients as shown in FIG. 1) that may each be a processing unit based device with sufficient memory, display capabilities, storage space, processing power and connectivity (wired or wireless) to access and interact with a photo system 16 over a communications link 14 (wired or wireless). For example, each computing device may be a personal computer, laptop computer, desktop computer, a wireless device, a wireless email device, an integrated device such as a RIM Blackberry or Palm Treo device, a mobile phone or a cellular phone. The link 14 is in turn connected to a firewall device 26 that protects the internal network from malicious activities by having all data into and out from the internal systems pass through the firewall. The internal systems (that are behind the firewall) may include one or more application web servers 28 (one or more of which may execute the photo book system 20 that may be implemented in software in one embodiment) that receive requests and information from the computing devices and generate one or more web pages that contain information that can be displayed in a known browser application being executed by each computing device. The system may also include a known database server 31 that receives data requests, queries a storage unit 33 (that stores the various data and information associated with the photo book system) and delivers the requested data to the appropriate system element and one or more rendering servers 32 that renders the bound image albums that are produced by the photo system. The photo system 16 may be used to upload images and then generate a photo album based on the uploaded images of the user.

The main client application (that interacts with Picaboo unit 12 in FIG. 1) is the Picaboo application. The web application is this implementation may include the private proxies, account verification, file transfers, order pages and/or preview. The server application in the implementation may include album publishing, image extraction, data synchronization, rendering, user gateway, user registration and the session server.

Each Picaboo client 12 may be implemented as a hardware unit, as a combination of hardware and software (such as a computing device with a plurality of lines of code being executed by the processor of the computing device) or a software which has a plurality of lines of code being executed by the processor of a computing device of the user who is executing the Picaboo client. The Picaboo client allows the user to interact with the photo book system. For example, the Picaboo client allows a user to layout one or more pieces of content so that a book, when completed, can be printed for the user.

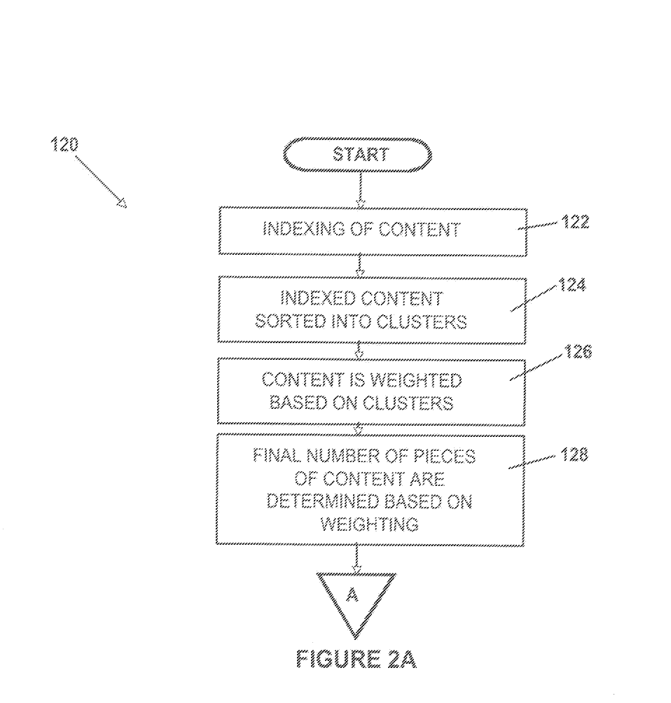

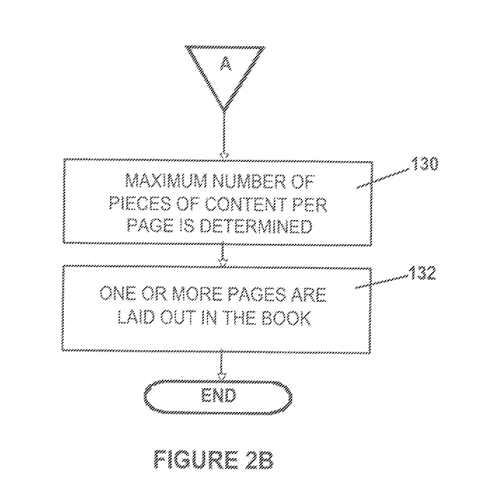

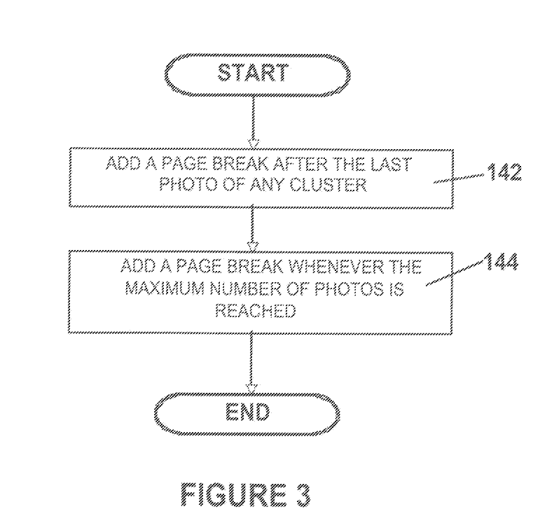

FIG. 1B illustrates more details of the computing device 102 of the photo story book system that includes the client 12. Each computing device 102 may include one or more processing units 104, one or more storage devices 106 (that may be various types of electronic/optical/magnetic, etc. storage devices and a memory 108 from which applications may be read into and then executed by the one or more processing units. For example, the memory may have an operating system 110 that controls the overall operation and functioning of the computing device as is well known and the client application 12 that is a plurality of lines of computer code that can be executed by the one or more processing units of the computing device. The client application performs various functions and operations including interfacing with the photo system 16. The client application 12 also may have a plurality of lines of computer code that implement the image clustering method and layout method as described below. The lines of computer code that implement the image clustering method and layout method may be a content clustering unit within the client application or it may be implemented as separate hardware and hardware/software. The content clustering unit may further comprise a plurality of components that implement the processes described below in FIGS. 2A-3. Alternatively, the image clustering method and layout method may be performed on the photo system and then the results are delivered to the client application. In one implementation, the part of the client application that implements the image clustering method and layout method) may be implemented as an Adobe® Air Application using the Flex 3.5 framework and the logic is written in the Actionscript 3.0 language and uses XML for all storage and data structures. Now, the image clustering method will be described in more detail.

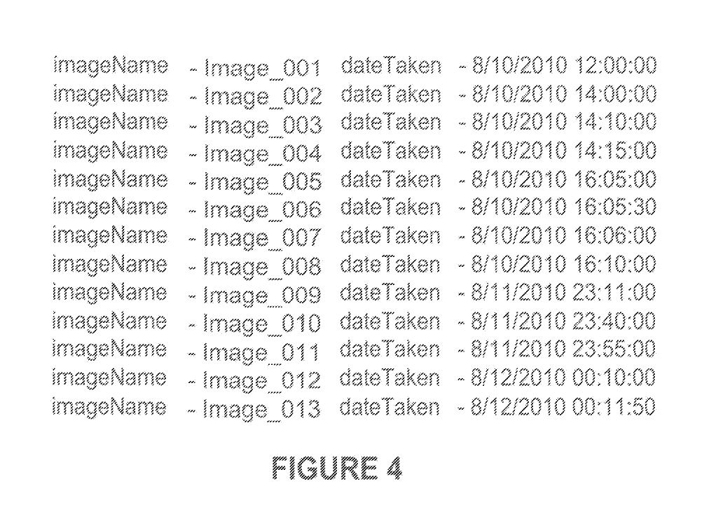

FIGS. 2A and 2B illustrate a image clustering and book layout method 120 that can be implemented using the photo story book system in FIG. 1. Initially, the photos/images of the user are indexed (122) (or have been previously indexed) based on metadata associated with each photo/image. The photos/images may be indexed in part based on the dates that the photos/images were taken and one or more images/photos are selected by the user for inclusion into a book that can be generated by the photo system. An example of the metadata associated with a set of photos/images is shown in FIG. 4. As shown in FIG. 4, the metadata may include for example, a photo/image name and a date/time that the photo/image is taken.

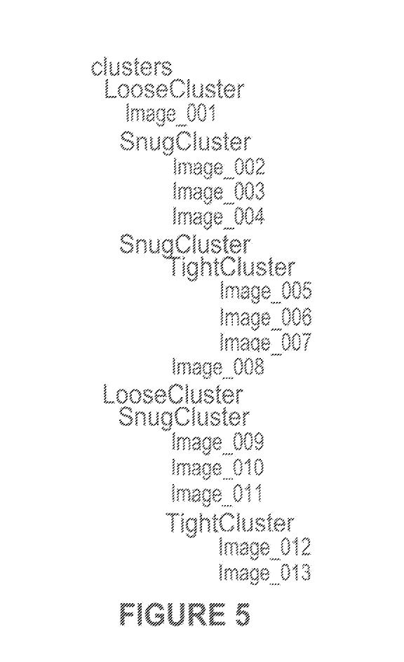

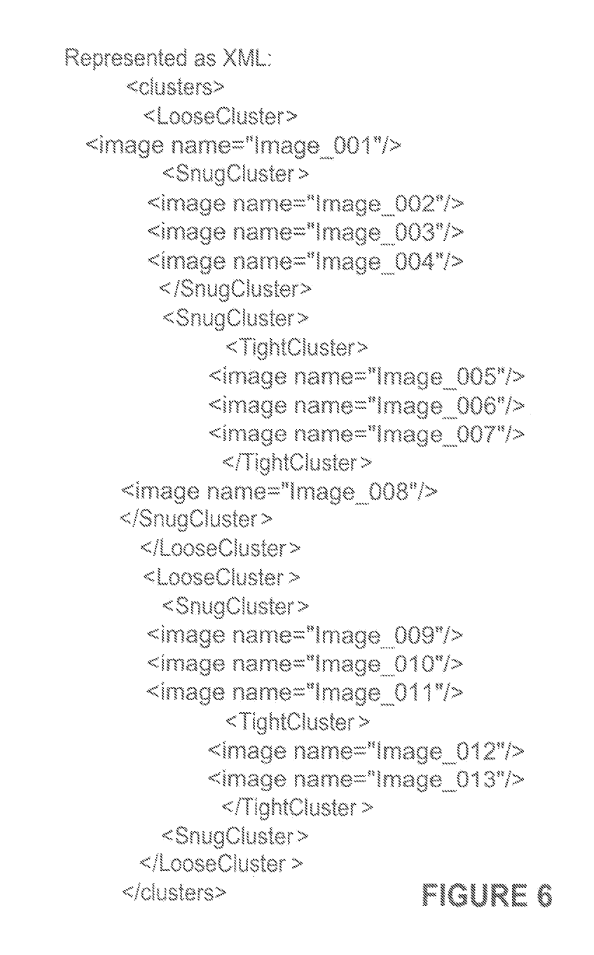

In the method, the images/photos are sorted into clusters (124). In one embodiment, the images/photos may be sorted into clusters based on the date/time that the photo/image was taken. In one implementation, the clusters may include loose clusters, snug clusters and tight clusters. Each loose cluster may include any photo/image taken on the same calendar day as the previous photo and those photos/images may be placed into a loose cluster. Each snug cluster may include any photo taken within an hour of the previous photo and those images/photos may be placed into a snug cluster. Each tight cluster may include any photo taken within two minutes of the previous photo and those images/photos may be placed into a tight cluster. An example of the photos/images sorted into clusters (based on the metadata shown in FIG. 4) are shown in FIGS. 5-6.

Once the photos/images are clustered together, each photos/images may be assigned a weight (126) based on the type of cluster that the photo/image is associated with. In particular, the “tighter” the cluster (a tight cluster is tighter than a snug cluster which is tighter than a loose cluster), the more likely there are a number of similar photos, and the looser the cluster, the more “special” the photo is more likely to be (e.g., less associated with other photos that have been selected for the book). Thus, in one embodiment, a photo/image only in a Loose cluster is two times more likely to be included in the book as a photo/image in a snug cluster and a photo/image only in a snug cluster is two times more likely to be included in the book as a photo/image in a tight cluster which is an example of the weighting above. For example, a photo/image in only a loose cluster is given an 80% weight, a photo/image only in a snug cluster is given a 40% weight and a photo/image in a tight cluster is given a 20% weight.

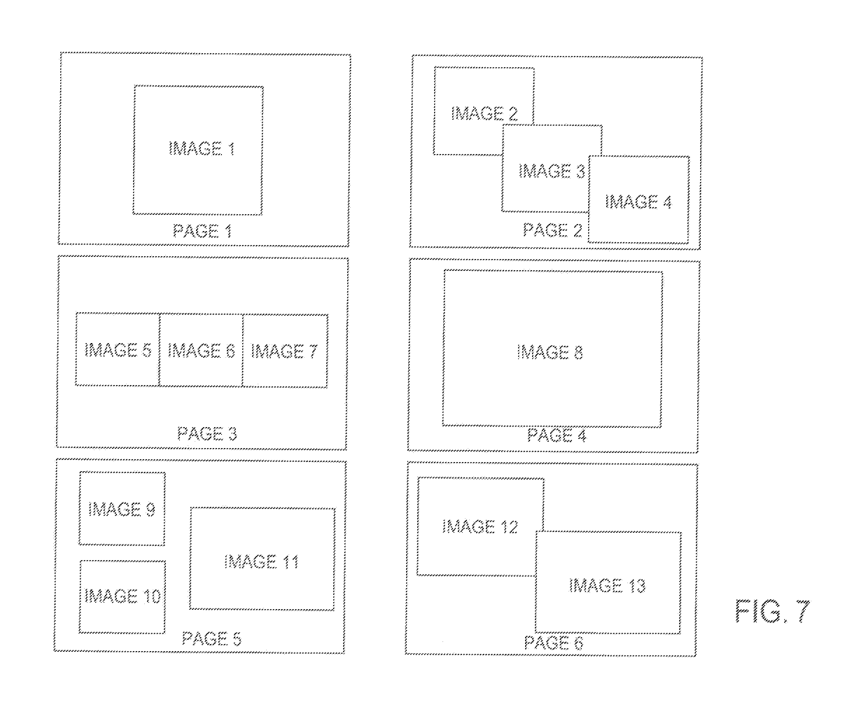

When the weighting is completed, the photos/image may be “removed” from the clusters based on their weight, to give a final number of photos/images, sufficient to adequately fill a certain size book (such as for example a 20 page book) (128). Based on the final number of photos/images to be included, a maximum number of photos/images per page is determined (130) In one implementation, the maximum number of photos/images may be calculated as the total number of Photos/20. Once the maximum number of photos/images per page is determined, the method may lay out the selected photos/images (132) based on the clusters and the maximum number of photos/images per page. An example of the user interface to a user of the images/photos automatically laid out for a six page book is shown in FIG. 7.

FIG. 3 illustrates more details of a layout method 140 that is part of the method shown in FIGS. 2A and 2B. In one implementation, the layout method may, for example, add a page break (142) after the last photo/image of any cluster. For example, as shown in FIG. 7, there is a page break after photo/images 2-4 as those photos/images were in a snug cluster as shown in FIGS. 5-6. The layout method also may add a page break (144) whenever the maximum number of photos is reached.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A content book generating system, comprising:
a content clustering unit, the content clustering unit having a component that receives a set of content, wherein each piece of content has metadata associated with the piece of content, a clustering component that, for each piece of content in the set of content, sorts each piece of content into one or more clusters with at least one other piece of content based on the metadata associated with each piece of content, each cluster indicating a different association of each piece of content in the cluster with the other pieces of content in the cluster, an assigning component that assigns a weight to each piece of content based on the types of the one or more clusters into which that the piece of content is sorted, wherein the weight indicates a likelihood that a particular piece of content will be placed into a book and a layout component that lays out one or more pages of the book based on the weights assigned to each piece of content; and
a display that displays the one or more pages of the book to the user.

2. The system of claim 1, wherein the content clustering unit further comprising a determining component that determines based on the weights of the pieces of content, a final number of pieces of content to fill the book.

3. The system of claim 2, wherein the content clustering unit further comprising a determining component that determines a maximum number of pieces of content per page of the book based on the final number of pieces of content.

4. The system of claim 2, wherein the layout component lays out one or more pages of the book based on the one or more clusters assigned to each piece of content that is part of the final number of pieces of content and based on the maximum number of pieces of content per page of the book.

5. The system of claim 1, wherein the clustering component sorts each piece of content into one of a loose cluster that includes any piece of content taken on the same calendar day as a previous piece of content, a snug cluster that includes any piece of content taken within an hour of a previous piece of content and a tight cluster that includes a piece of content taken within two minutes of a previous piece of content.

6. The system of claim 4, wherein the layout component lays out a new page in the book after each the piece of content in a particular cluster.

7. The system of claim 4, wherein the layout component lays out a new page in the book when the maximum number of pieces of content per page is exceeded.

8. A content clustering and layout method, comprising:
receiving a set of content, wherein each piece of content has metadata associated with the piece of content;
sorting each piece of content into one or more clusters with at least one other piece of content based on the metadata associated with each piece of content, each cluster indicating a different association of each piece of content in the cluster with the other pieces of content in the cluster'
assigning a weight to each piece of content based on the types of the one or more clusters into which that the piece of content is sorted, wherein the weight indicates a likelihood that a particular piece of content will be placed into a book; and
laying out one or more pages of the book based on the weights assigned to each piece of content.

9. The method of claim 8 further comprising determining, based on the weights of the pieces of content, a final number of pieces of content to fill the book.

10. The method of claim 9 further comprising determining a maximum number of pieces of content per page of the book based on the final number of pieces of content.

11. The method of claim 10, wherein laying out the one or more pages of the book further comprises laying out one or more pages of the book based on the one or more clusters assigned to each piece of content that is part of the final number of pieces of content and based on the maximum number of pieces of content per page of the book.

12. The method of claim 8, wherein sorting each piece of content in the set of content into one or more clusters further comprises one of sorting a piece of content into a loose cluster that includes any piece of content taken on the same calendar day as a previous piece of content, sorting a piece of content into a snug cluster that includes any piece of content taken within an hour of a previous piece of content and sorting a piece of content into a tight cluster that includes a piece of content taken within two minutes of a previous piece of content.

13. The method of claim 8, wherein each piece of content is an image.

14. The method of claim 8, wherein each piece of content is an photo.

15. The method of claim 11, wherein laying out the one or more pages of the book further comprises laying out a new page in the book after each the piece of content in a particular cluster.

16. The method of claim 11, wherein laying out the one or more pages of the book further comprises laying out a new page in the book when the maximum number of pieces of content per page is exceeded.

17. The method of claim 8 further comprising indexing each piece of content based on the metadata associated with each piece of content.

18. The method of claim 8 further comprising selecting the set of content to be used in the book.

19. The method of claim 8, wherein the metadata further comprises one of a content name and a date/time of content taken.

20. The method of claim 8 further comprising displaying the layout of the one or more pages of the book to the user and permitting the user to purchase the book with the one or more laid out pages.
